(19) United States
(12) Patent Application Publication
(10) Pub. No.: US 2004/0113131 A1
(43) Pub. Date: Jun. 17, 2004

(54) Phosphor of warm luminous colors and fluorescent display device

(75) Inventors: Takuya Hamada, Chiba (JP); Kazuhiko Itakura, Chiba (JP); Takao Shiraga, Chiba (JP); Kazunori Kitagawa, Chiba (JP); Hirokazu Takanashi, Chiba (JP); Hitoshi Toki, Chiba (JP)

Correspondence Address: BACON & THOMAS, PLLC, 625 SLATERS LANE, FOURTH FLOOR, ALEXANDRIA, VA, 22314

(73) Assignee: Futabu Corporation, Chiba (JP)

(21) Appl. No.: 10/724,062

(22) Filed: Dec. 1, 2003

(30) Foreign Application Priority Data
Dec. 2, 2002 (JP) 2002-349809

(51) Int. Cl. F21V 9/00

(52) U.S. Cl. 252/582

(57) ABSTRACT

A mixture phosphor is provided by mixing a phosphor of a red luminous color devoid of Cd with a phosphor of a green family luminous color also devoid of Cd, wherein a luminous color of the mixture phosphor is a warm color ranging from yellow to orange. And, in the mixture phosphor, S component is removed or less than that of the conventional phosphor of the warm luminous color. Accordingly, a dark streak may not appear or a dark streak appearing time may be delayed, thereby providing a fluorescent display device having an improved display quality.

### FIELD OF THE INVENTION

The present invention relates to a phosphor for a low energy electron beam driven by a low anode voltage of 1KV or below and a vacuum fluorescent display (VFD) using same; and, more particularly, to mixture phosphors for obtaining warm luminous colors from yellow to orange by mixing a phosphor of a red luminous color not containing an environmental load material Cd with phosphors of green family luminous colors not containing Cd as well.

### BACKGROUND OF THE INVENTION

A conventional vacuum fluorescent display has display electrodes formed inside an envelope of a flat box structure, the envelope being formed of an anode plate made of glass plate, a front plate arranged to face the anode plate and side plates of frame shape placed between the anode plate and the front plate. The display electrodes typically includes anode electrodes, each anode electrode having an anode conductor formed on an inner surface of the anode plate and a phosphor layer coated on the surface of the anode conductor, a mesh-shaped grid electrode disposed above the anode electrodes and at least one filament-shaped cathode electrode provided thereabove as an electron source.

Further, after being evacuated through, e.g., an exhaust hole or an exhaust chip tube by a vacuum pump, the inside of the envelope is sealed to be maintained at a high vacuum level by using an exhaust cover or welding off the exhaust chip tube. Moreover, to maintain the envelope at a high vacuum level by absorbing residual gases, a getter is placed inside the envelope.

When the vacuum fluorescent display is driven to emit light, electrons are radiated from the cathode electrode. The radiated electrons, after being accelerated and controlled by the grid electrode, impinge on the phosphor layer of the anode electrode. Then, the phosphor emits light.

A variety of phosphors emitting light at a low voltage level of several hundred V or below are used as those coated on the anode conductors. A ZnO:Zn phosphor which emits light in blue green is widely used, but phosphors which emit light in warm luminous colors are used also. Warm luminous colors typically denote and, more specifically, include luminous colors from yellow to red, luminous colors of greenish yellow, yellow, yellowish orange, orange, reddish orange, red and the like. As phosphors emitting light of warm luminous colors, (Zn₁₋ₓCdₓ)S:Au,Al (x=0.2˜0.7) is disclosed in Japanese Patent Laid-open Publication No. shoha56-11984. This material is known to emit light from orange to red depending on the content of Cd, i.e., the value of x.

Further, as alternative phosphors emitting light of warm luminous colors, (Zn₁₋ₓCd)S:Ag,Al (x=0.3˜0.9) is disclosed in Japanese Patent Laid-open Publication No. shoha55-99990. This material is known to emit light from yellow to red depending on the content of Cd, i.e., the value of x.

As described above, ZnCdS system phosphors are conventionally used as phosphors of warm luminous colors.

Furthermore, The first preferred embodiment of Japanese Patent Laid-open Publication No. shoha58-84884 discloses a vacuum fluorescent display in which a mixture phosphor emitting yellow light of a warm luminous color is provided by mixing a ZnCdS:Ag phosphor of a red luminous color and a ZnS:Cu,Al phosphor of a green family luminous color. All these phosphors contain Cd.

As described, conventional vacuum fluorescent displays contain Cd in phosphors of warm luminous colors, which is known as a health-affecting environmental load material. While the phosphor emits light in the envelope, there occurs no problem that should be concerned. However, in case the fluorescent display is discarded and trashed, the environment is polluted with Cd, although the amount may be small. Recently, strong public awareness for the environmental load material has led to a movement to bar the use of environmental load materials in manufactured goods. Accordingly, there is a possibility that the ZnCdS system phosphor becomes one of the barred materials.

Moreover, all the constituent phosphors of conventional mixture phosphors are ZnS or ZnCdS system phosphors. Both system phosphors contain sulfur(S) as a major component thereof and are called as sulfide phosphor. When these sulfide phosphors are used in a vacuum fluorescent display, the sulfide phosphor is decomposed by an electron beam radiated from a cathode electrode and the decomposed S is scattered in a display. Since S has a characteristic of traveling straight, the scattered S adheres to a portion of the filament-shaped cathode facing the phosphor. As the amount of adhered S increases, an emission rate of the portion of the cathode facing the phosphor decreases. In other words, the amount of the electron radiation is reduced. Then, the brightness of the phosphor right under the portion of the filament is lowered, thereby causing a dark streak phenomenon in which the brightness of the linear portion of the phosphor right under the filament is lowered, and the difference in brightness between the linear portion and the remaining portions can be noticed with bare eyes. The dark streak does not appear in an early stage of lighting-up time, but becomes noticeable after the accumulated lighting-up time becomes around 1000 hours.

### SUMMARY OF THE INVENTION

It is, therefore, a primary object of the present invention to provide phosphors capable of emitting light of warm luminous colors, e.g., greenish yellow, yellow, yellowish orange, orange, reddish orange and the like, by tailoring a mixing ratio of a phosphor of a red luminous color not containing the environmental load material Cd, e.g., a SrTiO₃-based phosphor, and a phosphor of a green family luminous color not containing Cd as well.

It is another object of the present invention to provide mixture phosphors of warm luminous colors and a vacuum fluorescent display employing same and capable of improving display quality by retarding the occurrence of dark streak to extend the lighting-up time without a dark streak to more than 2000 hours by way of removing or reducing the amount of S contained in the mixture phosphors.

In accordance with the present invention, there is provided a mixture phosphor by mixing a phosphor of a red luminous color devoid of Cd with a phosphor of a green family luminous color also devoid of Cd, wherein a luminous color of the mixture phosphor is a warm color ranging from yellow to orange.

### BRIEF DESCRIPTION OF THE DRAWINGS

The above and other objects and features of the present invention will become apparent from the following description of preferred embodiments given in conjunction with the accompanying drawings, in which:

FIG. 1 is a partially expanded cross sectional view of a vacuum fluorescent display of the present invention;

FIG. 2 shows a graph showing a relationship between a mixing ratio of a mixture phosphor and a dark streak appearing time of the present invention.

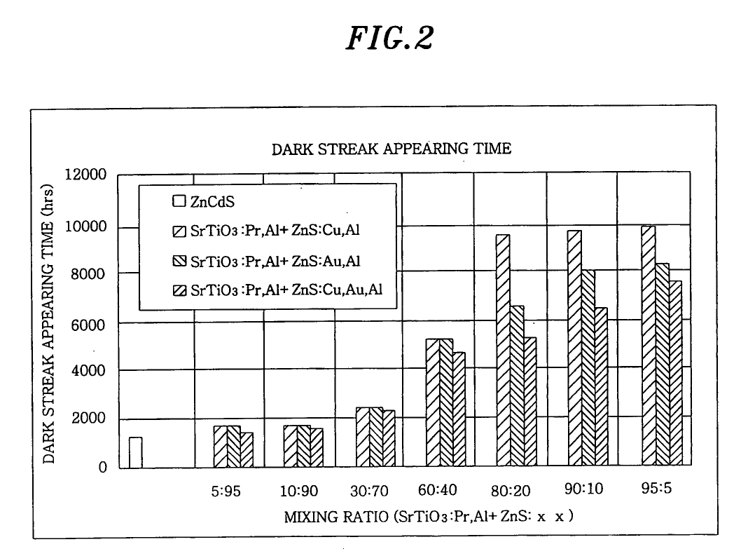

### DETAILED DESCRIPTION OF THE PREFERRED EMBODIMENTS

The present invention is directed to provide a phosphor emitting light of a desired warm luminous color by way of mixing and changing a mixing ratio of a phosphor of a red luminous color and a phosphor of a green family luminous color, neither of them containing environmental load material Cd.

The phosphor of a green family luminous color is defined herein as a phosphor emitting light in blue green, bluish green, green, yellowish green or yellow green. Further, the warm luminous color is defined as a luminous color of greenish yellow, yellow, yellowish orange, orange or reddish orange.

As an example of the above mentioned phosphor of a red luminous color not containing Cd, there is a SrTiO₃ system phosphor of a red luminous color which is developed by the present applicants. Specific examples of the SrTiO₃-based phosphor are SrTiO₃:Pr phosphor, SrTiO₃:Pr,Al phosphor and SrTiO₃:Pr,Ga phosphor, containing neither Cd nor S. Alternatively, Y₂O₃:Eu phosphor, Y₂O₂S:Eu phosphor or SnO₂:Eu phosphor can be used as the phosphor of a red luminous color not containing Cd.

As an example of the above mentioned phosphor of a green family luminous color not containing Cd, there is ZnS:Cu,Al phosphor, ZnS:Au,Al phosphor, ZnS:Cu phosphor, ZnS:Cu,Au,Al phosphor or ZnGa₂O₄:Mn phosphor. None of the previously stated phosphors of green family luminous colors contain Cd.

First preferred embodiment(Data Nos. 1 to 8)

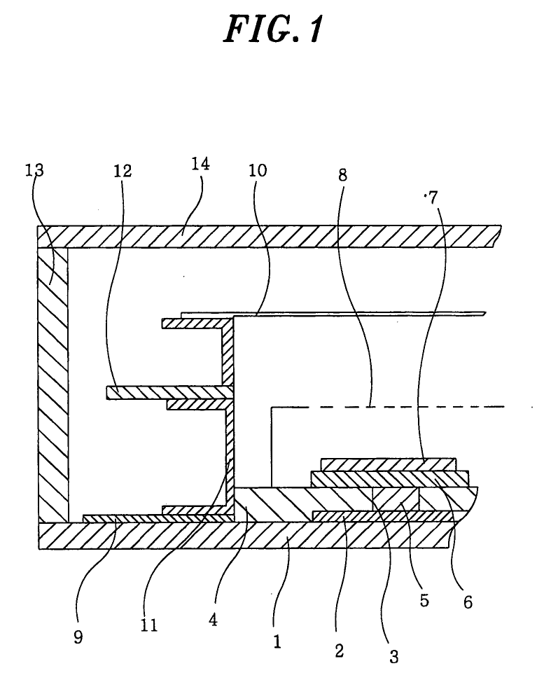

Referring to FIG. 1, the present invention will now be described in detail.

A wiring conductor 2 of a patterned thin aluminum film is formed photolithographically on an inner surface of an anode plate 1 being a part of a flat box structure envelope and made of glass plate. And an insulating layer 4 having a through hole 3 which exposes a part of the wiring conductor 2 is formed through the use of a thick film printing method by stacking thereon an insulating paste which has frit glass as a principal material. Then, the through hole 3 is filled with a conductor paste 5 containing particles of Ag, Al and the like by the thick film printing method. Next, an anode conductor 6 including a carbon layer is formed by the thick film printing method. On the anode conductor 6 is formed a phosphor layer 7.

The phosphor used in the phosphor layer 7 may obtain a desired luminous color by mixing the SrTiO₃:Pr,Al phosphor of a red luminous color with ZnS:Cu,Al phosphor of a green family luminous color at a mixing ratio given in Table l(from data 1 to data 8), wherein the mixing ratio of the phosphor of a red luminous color: the phosphor of a green family luminous color ranges from 5:95 to 95:5. A phosphor paste is made by mixing the mixture phosphor thus obtained with In₂O₃ as a conducting material by 3 w % thereof and further adding thereto a vehicle containing organic solvent. Then, the phosphor layer 7 is formed by coating the mixture phosphor paste on the surface of the anode conductor 6 by the screen printing method to complete the formation of the anode plate 1.

Above the anode electrode of the anode plate 1, a mesh-shaped grid 8 is arranged to be in contact with the wiring conductor 2. Further, at two opposite ends of the anode plate 1 are installed cathode supporting members 9, each made of a metal plate. Fixedly installed at the cathode supporting members 9 are anchors and supporters to which a filament-shaped cathode 10 is tautly hung.

Furthermore, there are provided attached getter fixing tabs 11, on which getters 12 are fixedly welded. By covering the anode plate 1 with a box structure container having a side plates 13 and a front plate 14, sealing up with glass glue, and evacuating the inner space of the envelope to vacuum, a vacuum fluorescent display was produced.

As a result of lighting the vacuum fluorescent display with 12V of a cathode voltage, 30V of a grid and an anode voltage, brightness data in an early stage and luminous colors were obtained as shown in Table 1. Besides, by analyzing the luminous colors in accordance with the chromaticity diagram, XY data appearing in CIE chromaticity coordinates column were obtained.

Though the CIE chromaticity coordinates and the luminous colors of data 1 and 2 correspond to green family of cold luminous colors, data from 3 to 8 belong to the warm luminous colors from yellow to orange. It has been found that when a mixing ratio of SrTiO₃:Pr,Al phosphor of a red luminous color to a phosphor of a green family luminous color ranges from 30:70 to 95:5, warm luminous colors can be obtained. Within this range, the content of ZnS:Cu,Al phosphor of a green family luminous color ranges from 5 to 70 w % of the mixture phosphor.

TABLE 1
SrTiO₃:Pr, Al phosphor of a red luminous
color and ZnS:Cu, Al phosphor of a green family
luminous color

| | Mixing ratio of | | | | |
|---|---|---|---|---|---|
| | phosphors | | | | |
| | (Phosphor of red | | | | |
| | luminous color: | | CIE | | |
| | phosphor of | | chromaticity | | |
| Data | green luminous | Brightness | coordinates | | Luminous |
| No. | color) | (Cd/m²) | X | Y | color |
| 1 | 5:95 | 265 | 0.320 | 0.588 | Yellowish |
| | | | | | green |
| 2 | 10:90 | 244 | 0.349 | 0.567 | Yellowish |
| | | | | | green |
| 3 | 30:70 | 224 | 0.448 | 0.494 | Greenish |
| | | | | | yellow |
| 4 | 50:50 | 205 | 0.480 | 0.490 | Yellow |
| 5 | 60:40 | 188 | 0.561 | 0.410 | Orange |
| 6 | 80:20 | 164 | 0.620 | 0.367 | Reddish |
| | | | | | orange |
| 7 | 90:10 | 152 | 0.646 | 0.388 | Reddish |
| | | | | | orange |
| 8 | 95:5 | 146 | 0.602 | 0.380 | Reddish |
| | | | | | orange |

### Second Preferred Embodiment (Data Nos. 9 to 16)

A second preferred embodiment of the present invention is identical to the first preferred embodiment excepting for a hosphor of a green family luminous color to be mixed with SrTiO₃:Pr,Al phosphor of a red luminous color. Since the structure and the working process of the vacuum fluorescent display are same as those in the first preferred embodiment, the description thereof will be omitted. The mixture phosphor to be used is a mixture of SrTiO₃:Pr,Al phosphor of a red luminous color and ZnS:Au,Al phosphor of a green family luminous color. As a result of lighting the vacuum fluorescent display with the mixture phosphor, the brightness data in an early stage, the ClE chromaticity coordinates and the luminous colors were obtained as shown in Table 2. Hereupon, the mixing ratio of the phosphor of a red luminous color to the phosphor of a green family luminous color also ranges from 5:95 to 95:5, which is equal to that of the first preferred embodiment.

TABLE 2
SrTiO₃:Pr, Al phosphor of a red luminous
color and ZnS:Au, Al phosphor of a green family
luminous color

| | Mixing ratio of | | | | |
|---|---|---|---|---|---|
| | phosphors | | | | |
| | (Phosphor of red | | | | |
| | luminous color: | | CIE | | |
| | phosphor of | | chromaticity | | |
| Data | green luminous | Brightness | coordinates | | Luminous |
| No. | color) | (Cd/m²) | X | Y | color |
| 9 | 5:95 | 169 | 0.382 | 0.550 | Yellowish |
| | | | | | green |
| 10 | 10:90 | 167 | 0.395 | 0.541 | Yellowish |
| | | | | | green |
| 11 | 30:70 | 161 | 0.448 | 0.500 | Greenish |
| | | | | | yellow |
| 12 | 50:50 | 160 | 0.450 | 0.465 | Yellow |
| 13 | 60:40 | 158 | 0.476 | 0.478 | Yellow |
| 14 | 80:20 | 146 | 0.600 | 0.384 | Orange |
| 15 | 90:10 | 143 | 0.634 | 0.357 | Reddish |
| | | | | | orange |
| 16 | 95:5 | 142 | 0.652 | 0.344 | Reddish |
| | | | | | orange |

Though the data 9 and 10 correspond to the green family, the data from 11 to 16 belong to the warm luminous colors from yellow to orange. It has been found that when a mixing ratio of SrTiO₃:Pr,Al phosphor of a red luminous color to ZnS:Au,Al phosphor of a green family luminous color ranges from 30:70 to 95:5, warm luminous colors can be obtained. Within this range, the content of the phosphor of a green family luminous color ranges from 5 to 70 w % of the mixture phosphor.

### Third Preferred Embodiment

A third preferred embodiment of the present invention is identical to the first preferred embodiment excepting for the phosphor of a green family luminous color to be mixed with the phosphor of a red luminous color. Since the structure and the working process of the vacuum fluorescent display are same as those in the first preferred embodiment, the description thereof will be omitted. The mixture phosphor to be used is a mixture of SrTiO₃:Pr,Al phosphor of a red luminous color and ZnS:Cu phosphor of a green family luminous color. As a result of lighting the vacuum fluorescent display with the mixture phosphor, the brightness data in an early stage, the ClE chromaticity coordinates and the luminous colors were obtained as shown in Table 3. Hereupon, the mixing ratio of the phosphor of a red luminous color to the phosphor of a green family luminous color also ranges from 5:95 to 95:5, which is equal hat of the first preferred embodiment.

TABLE 3
SrTiO₃:Pr, Al phosphor of a red luminous
color and ZnS:Cu phosphor of a green family
luminous color

| | Mixing ratio of | | | | |
|---|---|---|---|---|---|
| | phosphors | | | | |
| | (Phosphor of red | | | | |
| | luminous color: | | CIE | | |
| | phosphor of | | chromaticity | | |
| Data | green luminous | Brightness | coordinates | | Luminous |
| No. | color) | (Cd/m²) | X | Y | color |
| 17 | 5:95 | 197 | 0.294 | 0.523 | Yellowish |
| | | | | | green |
| 18 | 10:90 | 194 | 0.308 | 0.516 | Yellowish |
| | | | | | green |
| 19 | 30:70 | 182 | 0.370 | 0.484 | Yellow |
| | | | | | green |
| 20 | 50:50 | 176 | 0.450 | 0.460 | Yellow |
| 21 | 60:40 | 164 | 0.480 | 0.428 | Yellowish |
| | | | | | orange |
| 22 | 80:20 | 152 | 0.567 | 0.383 | Orange |
| 23 | 90:10 | 146 | 0.617 | 0.357 | Reddish |
| | | | | | orange |
| 24 | 95:5 | 143 | 0.643 | 0.344 | Reddish |
| | | | | | orange |

Though data from 17 to 19 correspond to the green family, data from 20 to 24 belong to the warm luminous colors from yellow to orange. It has been found that when a mixing ratio of SrTiO₃:Pr,Al phosphor of a red luminous color to ZnS:Cu phosphor of a green family luminous color ranges from 50:50 to 95:5, warm luminous colors can be obtained. Within this range, the content of the phosphor of a green family luminous color ranges from 5 to 50 w % of the mixture phosphor.

### Fourth Preferred Embodiment (Data Nos. 25 to 32)

A fourth preferred embodiment of the present invention is identical to the first preferred embodiment excepting for the phosphor of a green family luminous color to be mixed with the phosphor of a red luminous color. Since the structure and the working process of the vacuum fluorescent display are same as those in the first preferred embodiment, the description thereof will be omitted. The mixture phosphor to be used is a combination of SrTiO₃:Pr,Al phosphor of a red luminous color and ZnS:Cu,Au,Al phosphor of a green family luminous color. As a result of lighting the fluorescent display device with the mixture phosphor, the brightness data in an early stage, the ClE chromaticity coordinates and the luminous colors were obtained as shown in Table 4. Hereupon, the mixing ratio of the phosphor of a red luminous color to the phosphor of a green family luminous color also ranges from 5:95 to 95:5, which is equal to that of the first preferred embodiment.

TABLE 4
SrTiO₃:Pr,Al phosphor of a red luminous
color and ZnS:Cu, Au, Al phosphor of a green family luminous
color

| | Mixing ratio of | | | | |
|---|---|---|---|---|---|
| | phosphors | | | | |
| | (Phosphor of red | | | | |
| | luminous color: | | CIE | | |
| | phosphor of | | chromaticity | | |
| Data | green luminous | Brightness | coordinates | | Luminous |
| No. | color) | (Cd/m²) | X | Y | color |
| 25 | 5:95 | 197 | 0.304 | 0.610 | Yellowish |
| | | | | | green |
| 26 | 10:90 | 194 | 0.317 | 0.599 | Yellowish |
| | | | | | green |
| 27 | 30:70 | 182 | 0.378 | 0.533 | Yellow |
| | | | | | green |
| 28 | 50:50 | 172 | 0.475 | 0.494 | Yellow |
| 29 | 60:40 | 164 | 0.485 | 0.471 | Yellow |
| 30 | 80:20 | 152 | 0.570 | 0.406 | Orange |
| 31 | 90:10 | 146 | 0.618 | 0.370 | Reddish |
| | | | | | orange |
| 32 | 95:5 | 143 | 0.643 | 0.350 | Reddish |
| | | | | | orange |

Though data from 25 to 27 correspond to the green family, data from 28 to 32 belong to the warm luminous colors from yellow to orange. It has been found that when a mixing ratio of SrTiO₃:Pr,Al phosphor of a red luminous color to ZnS:Cu,Au,Al phosphor of a green family luminous color ranges from 50:50 to 95:5, warm luminous colors can be obtained. Within this range, the content of phosphor of a green family luminous color ranges from 5 to 50 w % of the mixture phosphor.

### Fifth Preferred Embodiment (Data Nos. 33 to 40)

A fifth preferred embodiment of the present invention is identical to the first preferred embodiment excepting for the phosphor of a green family luminous color to be mixed with the phosphor of a red luminous color. Since the structure and the working process of the vacuum fluorescent display are same as those in the first preferred embodiment, the description thereof will be omitted. The mixture phosphor to be used is a combination of SrTiO₃:Pr,Al phosphor of a red luminous color and ZnGa₂O₄:Mn phosphor of a green family luminous color which do not contain S. As a result of lighting the vacuum fluorescent display with the mixture, the brightness data in an early stage, the ClE chromaticity coordinates and the luminous colors were obtained as shown in Table 5. Hereupon, the mixing ratio of the phosphor of a red luminous color to the phosphor of a green family luminous color also ranges from 5:95 to 95:5, which is equal to that of the first preferred embodiment.

TABLE 5
SrTiO₃:Pr, Al phosphor of a red luminous
color and ZnGa₂O₄:Mn phosphor of a green
family luminous color

| | Mixing ratio of | | | | |
|---|---|---|---|---|---|
| | phosphors | | | | |
| | (Phosphor of red | | | | |
| | luminous color: | | CIE | | |
| | phosphor of | | chromaticity | | |
| Data | green luminous | Brightness | coordinates | | Luminous |
| No. | color) | (Cd/m²) | X | Y | color |
| 33 | 5:95 | 102 | 0.139 | 0.396 | Bluish |
| | | | | | green |
| 34 | 10:90 | 104 | 0.177 | 0.668 | Green |
| 35 | 30:70 | 112 | 0.314 | 0.574 | Yellow |
| | | | | | green |
| 36 | 50:50 | 119 | 0.450 | 0.462 | Yellow |
| 37 | 60:40 | 124 | 0.486 | 0.456 | Yellow |
| 38 | 80:20 | 132 | 0.584 | 0.389 | Orange |
| 39 | 90:10 | 136 | 0.628 | 0.359 | Reddish |
| | | | | | orange |
| 40 | 95:5 | 138 | 0.649 | 0.344 | Reddish |
| | | | | | orange |

Though data from 33 to 35 correspond to the green family, data from 36 to 40 belong to the warm luminous colors from yellow to orange. It has been found that when a mixing ratio of SrTiO₃:Pr,Al phosphor of a red luminous color to ZnGa₂O₄:Mn phosphor of a green family luminous color ranges from 50:50 to 95:5, warm luminous colors can be obtained. Within this range, the content of the phosphor of a green family luminous color ranges from 5 to 50 w % of the mixture phosphor.

As described above in the section of Background of the Invention with respect to the dark streak generation mechanism, even if a sulfide phosphor is used, the dark streak does not appear in the early stage of lighting-up time. As the lighting-up time accumulates, however, the sulfide gradually piles up on a portion of a filament-shaped cathode facing the phosphor, causing a decrease in an emission rate at the portion. Eventually, the brightness of the phosphor right under the portion of the filament gets lowered. When a difference in brightness becomes equal to or bigger than about 10%, the difference can be noticeable with bare eyes and the dark streak phenomenon can be identified. However, if the accumulated lighting-up time before the dark streak begins to appear is longer than 2000 hours, it can be of a practical use.

Table 6 shows the dark streak appearing time of a conventional (Zn₁₋ₓ Cdₓ)S system phosphor, and a relationship between the dark streak appearing time and the mixing ratio of SrTiO₃:Pr,Al phosphor of a red luminous color and phosphors of green family luminous colors as in the first, second and fourth preferred embodiments of the present invention.

It can be seen that when the mixing ratio of the sulfide phosphor is not greater than 70 w % of the mixture phosphor, the dark streak appearing time becomes equal to or longer than 2000 hours.

TABLE 6
Dark streak appearing time (hours)

| | | Mixture phosphor | | |
|---|---|---|---|---|
| Mixing | | Of the invention | | |
| ratio of | Conventional | First | Second | Fourth |
| phosphors | example ZnCdS | embodiment | embodiment | embodiment |
| 5:95 | 1200 | 1630 | 1630 | 1400 |
| 10:90 | | 1700 | 1720 | 1600 |
| 30:70 | | 2500 | 2460 | 2320 |
| 60:40 | | 5200 | 5100 | 4600 |
| 80:20 | | 9700 | 6500 | 5230 |
| 90:10 | | 9800 | 8000 | 6450 |
| 95:5 | | 9900 | 8200 | 7500 |

The result from the third embodiment is omitted since it is same as that of the fourth embodiment. And since ZnGa₂O₄:Mn phosphor of a green family luminous color of the fifth preferred embodiment is a non-sulfide phosphor which does not contain S, no dark streak phenomenon occurs.

Though the above preferred embodiments of the present invention have been described by using the SrTiO₃:Pr,Al phosphor, other SrTiO₃ system phosphors of a red luminous color, such as SrTiO₃:Pr phosphor and SrTiO₃:Pr,Ga phosphor and the like, produce a same result. Further, Y₂O₃:Eu phosphor, Y₂O₂S:Eu phosphor and SnO₂:Eu phosphor are examples of the phosphors of a red luminous color which can be used in lieu of the SrTiO₃-based phosphor. Furthermore, as the phosphor of a green family luminous color other than the above described phosphors, Zn(Ga,Al)₂O₄ phosphor of a green family luminous color devoid of Cd can be used to produce a same result.

Since the mixture phosphor of the present invention, as described above, is formed by mixing a phosphor of a red luminous color not containing Cd, e.g., SrTiO₃ system phosphor with a phosphor of a green family luminous color also not containing Cd at a predetermined ratio, a phosphor of warm luminous color, which does not contain environmental load material and is also earth friendly, and a fluorescent display using same are provided.

Further, since in the mixture phosphor of the present invention, S component is removed or less than that of the conventional phosphors of warm luminous colors, the dark streak may not appear or the dark streak appearing time may be delayed, providing a fluorescent display device having improved display quality.

While the invention has been shown and described with respect to the preferred embodiments, it will be understood by those skilled in the art that various changes and modifications may be made without departing from the spirit and scope of the invention as defined in the following claims.

What is claimed is:

1. A mixture phosphor comprising:
a phosphor of a red luminous color devoid of Cd; and
a phosphor of a green family luminous color devoid of Cd,
wherein a luminous color of the mixture phosphor is one of warm colors ranging from greenish yellow, yellow, yellowish orange, orange and reddish orange and red.

2. The mixture phosphor of claim 1, wherein the phosphor of the red luminous color is a SrTiO₃-based phosphor.

3. The mixture phosphor of claim 1, wherein the phosphor of the red luminous color is SrTiO₃:Pr.

4. The mixture phosphor of claim 1, wherein the phosphor of the red luminous color is SrTiO₃:Pr,Al.

5. The mixture phosphor of claim 1, wherein the phosphor of the green family luminous color is ZnS:Cu,Al phosphor or ZnS:Au,Al phosphor, and a mixing ratio of the phosphor of the green family luminous color is about 5 to about 70 wt % of the mixture phosphor.

6. The mixture phosphor of claim 1, wherein the phosphor of the green family luminous color is ZnS:Cu phosphor or ZnS:Cu,Au,Al phosphor, and a mixing ratio of the phosphor of the green family luminous color is about 5 to about 50 wt % of the mixture phosphor.

7. The mixture phosphor of claim 1, wherein the phosphor of the green family luminous color is ZnGa₂O₄:Mn phosphor, and a mixing ratio of the phosphor of the green family luminous color is about 5 to about 50 wt % of the mixture phosphor.

8. A fluorescent display device comprising:
a vacuum envelope including:
an anode electrode formed by pasting the phosphor of claim 1 on an anode conductor; and
an electron source, for radiating electrons, arranged in a vacuum envelope.

9. A fluorescent display device comprising:
a vacuum envelope including:
an anode electrode formed by pasting the phosphor of claim 2 on an anode conductor; and
an electron source, for radiating electrons, arranged in a vacuum envelope.

10. A fluorescent display device comprising:
a vacuum envelope including:
an anode electrode formed by pasting the phosphor of claim 3 on an anode conductor; and
an electron source, for radiating electrons, arranged in a vacuum envelope.

11. A fluorescent display device comprising:
a vacuum envelope including:
an anode electrode formed by pasting the phosphor of claim 4 on an anode conductor; and
an electron source, for radiating electrons, arranged in a vacuum envelope.

12. A fluorescent display device comprising:
a vacuum envelope including:
an anode electrode formed by pasting the phosphor of claim 5 on an anode conductor; and an electron source, for radiating electrons, arranged in a vacuum envelope.

13. A fluorescent display device comprising:
a vacuum envelope including:
an anode electrode formed by pasting the phosphor of claim 6 on an anode conductor; and
an electron source, for radiating electrons, arranged in a vacuum envelope.

14. A fluorescent display device comprising:
a vacuum envelope including:
an anode electrode formed by pasting the phosphor of claim 7 on an anode conductor; and
an electron source, for radiating electrons, arranged in a vacuum envelope.
